(19) United States
(12) Patent Application Publication
(10) Pub. No.: US 2020/0081433 A1
(43) Pub. Date: Mar. 12, 2020

(54) Self-Driving Security Checking and Boarding Vehicle System

(71) Applicant: INTERNATIONAL BUSINESS MACHINES CORPORATION, ARMONK, NY (US)

(72) Inventors: Yan Sun, Shenzhen (CN); Li Li, Singapore (SG)

(21) Appl. No.: 16/129,426

(22) Filed: Sep. 12, 2018

(51) Int. Cl. G05D 1/00; G08G 1/00; G07C 9/00

(52) U.S. Cl. CPC G05D 1/0088; G05D 2201/0212; G07C 9/00563; G08G 1/202

(57) ABSTRACT

A computer-implemented method for providing secure transport in a transportation facility. In one embodiment, the computer-implemented method receives a request for a secure transport service from a requesting device, and receives traveler information associated with the request for the secure transport service. The computer-implemented method selects a secure transport vehicle based on the traveler information. The computer-implemented method initiates a security check of travelers and baggage items on the secure transport vehicle. The computer-implemented method initiates security measures in response to a determination that the travelers and baggage items failed the security check. The computer-implemented method initiates transport of the travelers and baggage items on the secure transport vehicle to a boarding area based on the traveler information in response to a determination that the travelers and baggage items passed the security check.

### BACKGROUND

The present disclosure relates generally to systems and methods for providing secure transport of individuals in a transportation facility such as, but not limited to, an airport, train station, subway station, or bus station.

Large numbers of people pass through airports or other transportation facilities every day. The process of moving about a transportation facility is often tedious and time-consuming. For instance, the security check at airports normally takes a long time, especially when travelers have to wait in queue or are not familiar with the security process. Additionally, luggage check-in and personal security check are two separate processes which add to the overall travel time. Further, after checked luggage is processed at an airline counter, carry-on luggage may still contain items which must pass a security check. The current process creates a lot of time uncertainty. Moreover, some travelers may be unaware of how long it takes to reach a particular boarding gate, which creates additional anxiety and may result in a traveler missing a flight.

### SUMMARY

In one aspect, the disclosed embodiments include a system, computer program product, and computer-implemented method for providing secure transport of individuals in a transportation facility. In one embodiment, the computer-implemented method receives a request for a secure transport service from a requesting device, and receives traveler information associated with the request for the secure transport service. The computer-implemented method selects a secure transport vehicle based on the traveler information. The computer-implemented method initiates a security check of travelers and baggage items on the secure transport vehicle. The computer-implemented method initiates security measures in response to a determination that the travelers and baggage items failed the security check. The computer-implemented method initiates transport of the travelers and baggage items on the secure transport vehicle to a boarding area based on the traveler information in response to a determination that the travelers and baggage items passed the security check.

Other embodiments and advantages of the disclosed embodiments are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a secure transport system in accordance with an embodiment of the present disclosure.

FIG. 2 is a schematic diagram illustrating a secure transport software architecture in accordance with an embodiment of the present disclosure.

FIG. 3 is a block diagram illustrating a secure transport vehicle in accordance with an embodiment of the present disclosure.

FIG. 4 is flowchart illustrating a process for providing secure transport of individuals in a transportation facility in accordance with an embodiment of the present disclosure.

FIG. 5 is a block diagram illustrating a hardware architecture of a system according to an embodiment of the present disclosure.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to”. Unless otherwise indicated, as used throughout this document, “or” does not require mutual exclusivity, and the singular forms “a”, “an” and “the” are intended to include the plural forms as well, unless the context clearly indicates otherwise.

A module or unit as referenced herein may comprise one or more hardware or electrical components such as electrical circuitry, processors, and memory that may be specially configured to perform a particular function. The memory may be volatile memory or non-volatile memory that stores data such as, but not limited to, computer executable instructions, machine code, and other various forms of data. The module or unit may be configured to use the data to execute one or more instructions to perform one or more tasks. In certain instances, a module may also refer to a particular set of functions, software instructions, or circuitry that is configured to perform a specific task. For example, a module may comprise of software components such as, but not limited to, data access objects, service components, user interface components, application programming interface (API) components; hardware components such as electrical circuitry, processors, and memory; and/or a combination thereof. As referenced herein, computer executable instructions may be in any form including, but not limited to, machine code, assembly code, and high-level programming code written in any programming language.

Also, as used herein, the term “communicates” means capable of sending and/or receiving data over a communication link. The communication link may include both wired and wireless links, and may be a direct link or may comprise of multiple links passing through one or more communication networks or network devices such as, but not limited to, routers, firewalls, servers, and switches. The communication networks may be any type of wired or wireless network. The networks may include private networks and/or public networks such as the Internet. Additionally, in certain embodiments, the term communicates may also encompass internal communication between various components of a system and/or with an external input/output device such as a keyboard or display device.

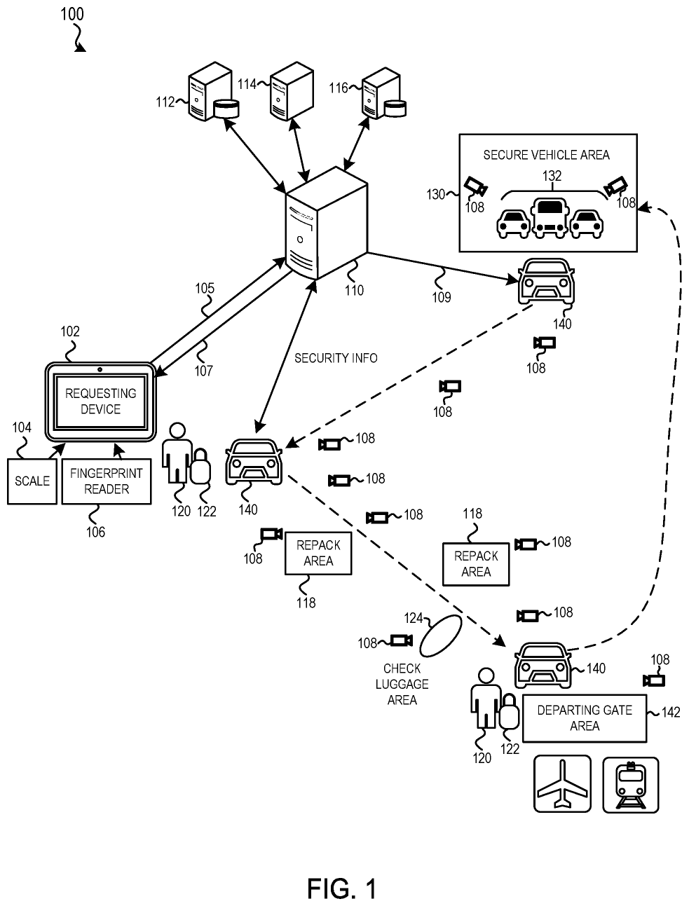

FIG. 1 is a schematic diagram illustrating a secure transport system 100 in accordance with an embodiment of the present disclosure. In the depicted embodiment, the secure transport system 100 includes a requesting device 102 that is configured to communicate with a secure transport control system 110 for providing secure transport of a traveler 120 in a transportation facility via a secure transport vehicle 140. The disclosed embodiments may be applicable at any type of transportation facility. Non-limiting examples of transportation facilities include airports, train/subway stations, bus stations, and ferry or boat terminals.

Although only a single traveler 120 is depicted, the traveler 120 is representative of any number of travelers such as, but not limited to, a single traveler, a couple, a family, or a group of people that are traveling together. The traveler 120 may also be traveling with any number of baggage items 122. Baggage items 122 can include luggage that may be checked at a baggage counter, carry-on luggage, or personal items such as a laptop bag or purse.

The requesting device 102 may be any type of electronic device such as, but not limited to, a mobile device, a personal computer, or a kiosk that is configured to communicate with the secure transport control system 110. In some embodiments, the requesting device 102 may be located at designated areas of the transportation facility such as, but not limited to, a passenger drop-off area, a transportation service provider check-in area, or a secure area of the transportation facility. In certain embodiments, the requesting device 102 may belong to the traveler 120. For example, an application may be installed on a mobile device of the traveler 120 that enables the traveler 120 to communicate a request 105 to the secure transport control system 110 for a secure transport vehicle 140.

In certain embodiments, as part of the request 105 for the secure transport vehicle 140, the requesting device 102 may transmit various traveler information to the secure transport control system 110. For example, the requesting device 102 may include a fingerprint reader 106 for capturing a fingerprint of the traveler 120. The requesting device 102 may also include a camera for capturing an image of the traveler 120. As an additional security measure, in certain embodiments, the requesting device 102 may communicate with a scale 104. The scale 104 may be used to measure a weight of each of the travelers 120 and baggage items 122. The weight measurements may be used to ensure that only the designated travelers 120 and baggage items 122 are transported on the secure transport vehicle 140.

In the depicted embodiment, the secure transport control system 110 is configured to receive the request 105 and traveler information from the requesting device 102. The secure transport control system 110 may be located within the transportation facility or may be located remotely away from the transportation facility. In various embodiments, the secure transport control system 110 may communicate with one or more systems to service the request 105. As non-limiting examples, the secure transport control system 110 may communicate with a travel information database system 112, a payment system 114, and an identification system 116. The travel information database system 112 may be queried by the secure transport control system 110 to obtain travel information associated with the traveler 120 such as flight information, departing gate, boarding time, verifying that the traveler 120 is not listed on the no-fly list, and passport information. The payment system 114 may be used to process payment for providing the secured transport service. The identification system 116 may be used to confirm the identity of the traveler 120 using fingerprint, facial recognition, passport information, or some other form of identification.

In one embodiment, the secure transport control system 110 is configured to communicate with at least one secured transport vehicle 140. The secure transport vehicle 140 may be parked or stored in a secure vehicle area 130 in the transportation facility. A plurality of secured transport vehicles 132 may be stowed within the secure vehicle area 130. The secured vehicle area 130 may be monitored by one or more security cameras 108 as well as other sensors (e.g., motion, temperature, etc.) to ensure that the secured transport vehicles 132 are not tampered with. In one embodiment, the secured transport vehicles 132 are self-driving vehicles that do not require a human driver. As will be further described, the secured transport vehicles 132 are equipped with scanning devices and security components to ensure that the traveler 120 and baggage items 122 meet the security requirements of the transportation facility.

In one embodiment, in response to the request and the traveler information, the secure transport control system 110 selects a particular secure transport vehicle 140 from the plurality of secured transport vehicles 132 based on the number of travelers 120 and baggage items 122. In one embodiment, the secure transport control system 110 communicates traveler data 109 to the selected secure transport vehicle 140. The traveler data 109 may include a current location of the traveler 120, a number of travelers, a number of baggage items and sizes, weight information of the traveler 120 and baggage items 122, and departure information such as boarding time, gate information, and flight number. The secure transport control system 110 may communicate an acknowledgment message 107 back to the requesting device 102 to provide an estimated time of arrival of the secure transport vehicle 140 at the pickup location of the traveler 120.

In one embodiment, the selected secure transport vehicle 140 is operated in an open non-restricted environment where other travelers in the transportation facility may be present or freely moving about. To ensure that no unauthorized travelers or items are placed on the secure transport vehicle 140 during transport, the secure transport control system 110 monitors the secure transport vehicle 140 using a plurality of security cameras 108 from the time it departs the secure vehicle area 130, when it arrives and picks up the traveler 120 and baggage items 122, and during transport of the traveler 120 and baggage items 122 to a departing gate area 142. Other means of monitoring the security of the secure transport vehicle 140 may also be used. The secure transport vehicle 140 may also include location tracking components that enable the secure transport control system 110 to constantly monitor the location of the secure transport vehicle 140.

In an alternative embodiment, the secure transport vehicle 140 may be operated in a closed restricted environment. For example, in one embodiment, the secure transport vehicle 140 may operate in secured passageways within the transportation facility between the secure vehicle area 130 to the location of the traveler 120, and then to the departing gate area 142. In certain embodiments, the traveler 120 may also be located in a secured area.

In some embodiments, the secure transport vehicle 140 may operate on a track system that guides the vehicle. For instance, the secure transport vehicle 140 may be a pod like structure that operates on a track system. Even in a closed restricted environment, the secure transport control system 110 may be configured to provide security monitoring of the secure transport vehicle 140 during transport to ensure that no unauthorized travelers or items are placed on the secure transport vehicle 140.

In one embodiment, once the secure transport vehicle 140 arrives at the location of the traveler 120, the traveler 120 is instructed to board the secure transport vehicle 140 and place the baggage items 122 onto the secure transport vehicle 140. In certain embodiments, the secure transport vehicle 140 may include a secure baggage compartment for holding and transporting the baggage items 122. As will be further described, the secure baggage compartment may be configured with one or more x-ray or terahertz scanners to scan the baggage items 122. The secure baggage compartment may also be configured with a locking mechanism. In one embodiment, the secure transport control system 110 is configured confirm that all the traveler 120 and baggage items 122 are on board the secure transport vehicle 140 to ensure that no items are left behind. The secure transport vehicle 140 may also include weight sensors to determine that the correct travelers and bags are onboard the secure transport vehicle 140.

Once all the travelers 120 and baggage items 122 are confirmed to be on board, the secure transport control system 110 may instruct the secure transport vehicle 140 to, or the secure transport vehicle 140 may be automatically configured to, initiate a security scan of the traveler 120 and the baggage items 122. In one embodiment, if a dangerous or suspicious item is detected in the baggage items 122, the secure transport vehicle 140 may be configured to maintain the baggage items 122 in the secure baggage compartment until a security personnel is able to review the item. Similarly, if a dangerous or suspicious item is detected on the traveler 120, the appropriate security personnel may be alerted.

In one embodiment, the secure transport vehicle 140 only proceeds to the departing gate area 142 when all security checks have been passed. In some embodiments, if the traveler 120 or baggage items 122 include items that are not permitted onboard the transportation vehicle (e.g., large liquids are not permitted onboard an aircraft) or the baggage items 122 are overweight, the secure transport vehicle 140 may be configured to provide instructions on a display to the traveler 120 that indicates the detected security issue. In one embodiment, the secure transport vehicle 140 may transport the traveler 120 to a repack area 118 to enable the traveler 120 to remove, repack, or dispose of particular items. If the baggage items 122 cannot be repacked to meet the carry-on requirements, the secure transport vehicle 140 may be instructed to proceed to a check luggage area 124.

Once all security checks have been passed, the secure transport vehicle 140 transports the traveler 120 and the baggage items 122 to the departing gate area 142 associated with the travel information of the traveler 120. In one embodiment, the distance and travel time to the departing gate area 142, along with the flight information, may be displayed on a display of the secure transport vehicle 140 so that the traveler 120 is aware of the time to reduce travel anxiety. At the departing gate area 142, the secure transport vehicle 140 is configured to instruct the traveler 120 to exit the secure transport vehicle 140 and to remove all the baggage items 122 from the secure transport vehicle 140. Using the security cameras 108 and/or the weight sensors in the secure transport vehicle 140, the secure transport vehicle 140, or the secure transport control system 110, may be configured to verify that all the travelers 120 and the baggage items 122 have been removed from the secure transport vehicle 140. If any items are left behind, an alarm or alert may be initiated to notify the traveler 120 or security personnel of the issue. Once the secure transport vehicle 140 is verified to be empty, the secure transport vehicle 140 is instructed to either return to the secure vehicle area 130 or to the location of another traveler 120.

In alternative embodiments, the secure transport control system 110 may be eliminated. For example, in one embodiment, the requesting device 102 may be configured to perform one or more functions of the secure transport control system 110, and communicate directly with a secure transport vehicle 140 for requesting secure transport of the traveler 120 and baggage items 122.

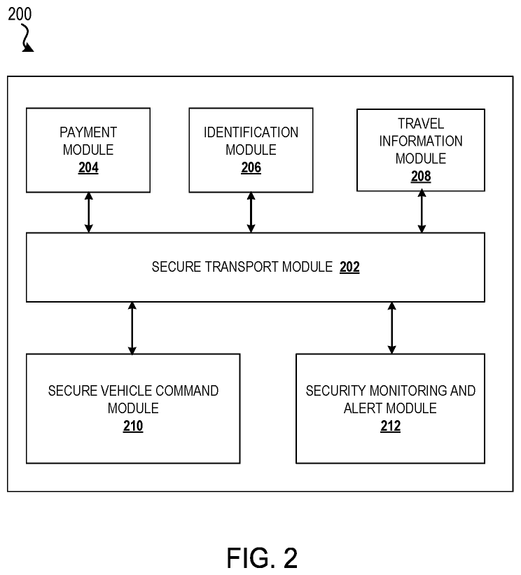

FIG. 2 is a schematic diagram illustrating a secure transport software architecture 200 in accordance with an embodiment of the present disclosure. The secure transport software architecture 200 may be implemented in control system such as, but not limited to, the secure transport control system 110 of FIG. 1. In the depicted embodiment, the secure transport software architecture 200 includes a secure transport module 202, a payment module 204, an identification module 206, a travel information module 208, a secure vehicle command module 210, and a security monitoring and alert module 212.

In one embodiment, the secure transport module 202 includes computer executable instructions that are configured to communicate with one or more requesting devices 102 to receive a request for secure transport service along with travel, payment, and identification information associated with one or more travelers. The secure transport module 202 is configured to pass the payment information to the payment module 204 to process payment for the secure transport service.

The secure transport module 202 is configured to pass the identification information such as, but not limited to, driver's license information, passport information, fingerprint data, and/or facial image data to the identification module 206. The identification module 206 may access or communicate with one or more systems such as government databases to verify the identities of the travelers. The identification module 206 may also access a no-fly list to ensure that the travelers are permitted to travel.

In one embodiment, the secure transport module 202 is configured to pass any travel information that it receives with a request to the travel information module 208 to verify the travel information of the travelers. Alternatively, in some embodiments, the secure transport module 202 may pass the identification and/or payment information to the travel information module 208 for enabling the travel information module 208 to retrieve travel information associated with the travelers. The travel information may include a travel itinerary that indicates the names of people traveling together, boarding time, departure time, departing gate area, flight number, and special traveling requests/requirements.

In one embodiment, once the payment, identification, and travel information have been retrieved or verified, the secure transport module 202 initiates the secure vehicle command module 210 to select a secure vehicle based on the number of travelers and baggage items. The secure vehicle command module 210 communicates the traveler information such as, but not limited to, the number of travelers and baggage items, weight information, and travel information to the selected secure vehicle. In one embodiment, if necessary, in response to receiving the traveler information, the selected secure vehicle proceeds to the location of the travelers.

In one embodiment, the security monitoring and alert module 212 is configured to monitor the secure transport vehicles while being stored in a secure vehicle area and during transport. The secure vehicle command module 210 may include instructions for initiating a security scan of the travelers and baggage items, identifying any prohibited items, instructing the travelers as necessary and alerting security personnel if needed. The secure vehicle command module 210 may further include instructions for ensuring that all and only authorized travelers and baggage items are placed on the secure transport vehicles, and that all items are removed at a departing gate area. The secure vehicle command module 210 may perform security monitoring using one or more cameras, weight sensors, and scanning devices.

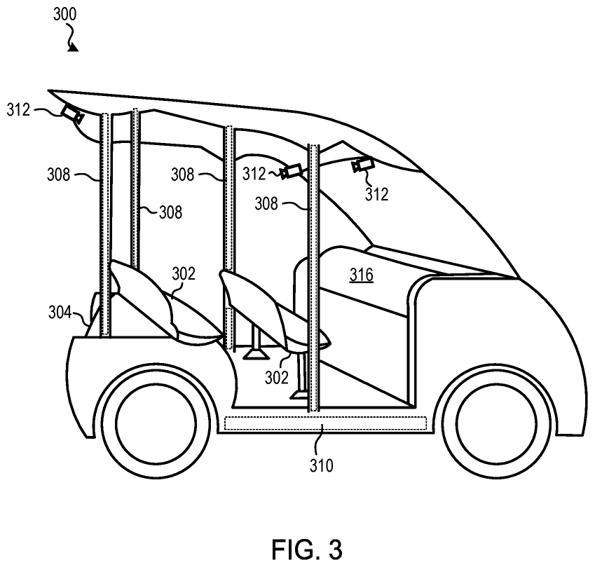

FIG. 3 is a block diagram illustrating an example of a secure transport vehicle 300 in accordance with an embodiment of the present disclosure. The secure transport vehicle 300 is a non-limiting example of the secure transport vehicle 140 of FIG. 1. As shown in FIG. 3, in one embodiment, the secure transport vehicle 300 is devoid of a steering device and acceleration/brake pedals. Instead, the secure transport vehicle 300 is a self-driving vehicle that does not require a human driver.

In the depicted embodiment, the secure transport vehicle 300 includes two bench seats 302 and an enclosed luggage security compartment 304 located in the back end of the secure transport vehicle 300. In one embodiment, the enclosed luggage security compartment 304 has a top or back cover that is able to be opened and closed for placing baggage items within the enclosed luggage security compartment 304. The enclosed luggage security compartment 304 may further include an electronic locking mechanism for securing the baggage items within the enclosed luggage security compartment 304. In one embodiment, components of an x-ray scanner or terahertz scanner may be built into the walls of the enclosed luggage security compartment 304 to enable a security scan to be performed on the baggage items within the enclosed luggage security compartment 304. In addition, a terahertz scanner 308 may be built into the frames and/or support posts of the secure transport vehicle 300 to enable a security scan to be performed on the travelers. The terahertz scanner 308 uses terahertz radiation or terahertz waves that consist of electromagnetic waves within the band of frequencies from 0.3 to 3 terahertz (THz; 1 THz=1012 Hz). Terahertz radiation is preferred over x-rays because it uses low photon energy that does not damage living tissues and DNA. Terahertz radiation can penetrate fabrics, plastics, and several millimeters of tissue to uncover concealed weapons or other unauthorized items.

In certain embodiments, the secure transport vehicle 300 may also include one or more weight sensors 310 that are configurable to determine a weight of the travelers and the baggage items. The measured weight may be compared against the weight of the travelers and baggage items that was determined beforehand to ensure that only authorized travelers and baggage items are being transported. The secure transport vehicle 300 may include one or more security cameras 312 or other security features to monitor the activities of the travelers and/or the surrounding environment.

In the depicted embodiment, the secure transport vehicle 300 includes a display 316 that may be used to display various information and instructions to the travelers. For example, in one embodiment, the secure transport vehicle 300 may display a map of the transportation facility, a route from the current location to a departing gate area, restrooms, shops or other places of interest along the route that a traveler may elect to stop at. The display 316 may also be used to display an estimated time of arrival, boarding time, or other travel information. If unauthorized or prohibited items are detected during the scan, and if appropriate, the display may provide instructions to the travelers to have the items removed or checked by security personnel.

As stated above, the secure transport vehicle 300 is just one example of a secure transport vehicle in accordance with the present disclosure. Other types of secure transport vehicles may also be used such as, but not limited to, an enclosed vehicle, a pod-like vehicle, and/or a vehicle that operates on a track like system with or without wheels. Additionally, in certain embodiments, the secure transport vehicle 300 may not include any security scanning devices for performing a security scan. Instead, in these embodiments, the secure transport vehicle 300 may simply provide transport after a traveler and their baggage items have passed a security check point.

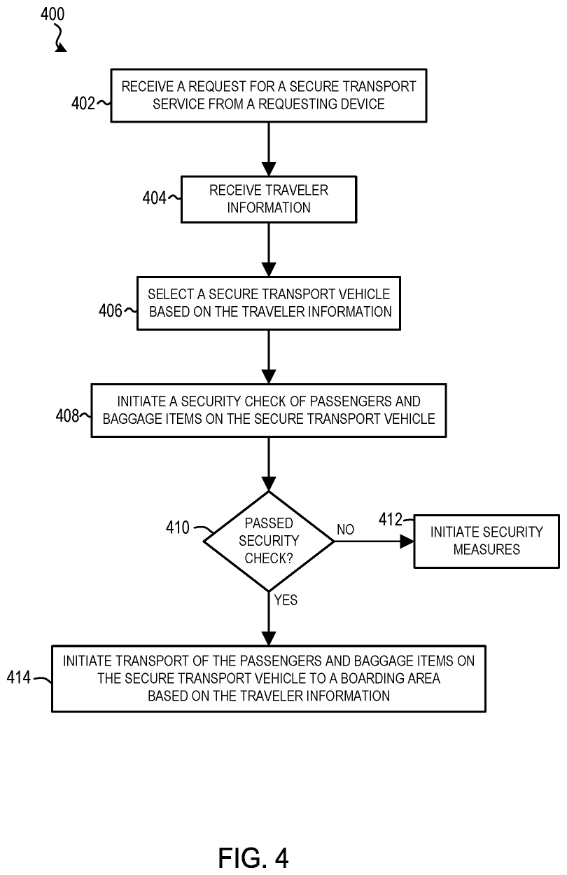

FIG. 4 is flowchart illustrating a process 400 for providing secure transport of individuals in a transportation facility in accordance with an embodiment of the present disclosure. The process 400 may be performed by a secure transport management system, such as the secure transport control system 110 in FIG. 1. Alternatively, in some embodiments, the process 400 may be performed by a requesting device such as requesting device 102 in FIG. 1, or by a secure transport vehicle such as the secure transport vehicle 140 in FIG. 1.

In the depicted embodiment, the process 400 begins, at step 402, receiving a request for a secure transport service from a requesting device. At step 404, the process 400 receives traveler information associated with the request. The traveler information may include identification information, weight information, number of travelers and baggage items, payment information, and flight information. In certain embodiments, the process 400 may verify the travel information.

At step 406, the process 400 selects a secure transport vehicle based on the traveler information. If needed, the process 400 may communicate instructions or travel information to the selected secure transport vehicle. Once the travelers and baggage items are on board the secure transport vehicle, the process 400, at step 408, initiates a security check of the travelers and baggage items on the secure transport vehicle. One or more security scans may be performed as part of the security check. For instance, a separate security scan may be performed on the baggage items and the travelers. Additionally, a weight measurement check may be performed to ensure that only the authorized travelers and baggage items are onboard the secure transport vehicle.

At step 410, the process 400 determines whether the travelers and baggage items passed the security check. If the travelers and baggage items fails the security check, the process 400, at step 412, initiates one or more security measures. The security measures may include alerting security personnel, maintaining the baggage items in a locked secure compartment, preventing movement of the secure transport vehicle, providing instructions to the travelers, transporting the travelers and baggage items to a security checkpoint, and initiating a re-scan of the travelers and baggage items.

If the travelers and baggage items pass the security check, the process 400, at step 414, initiates transport of the travelers and baggage items on the secure transport vehicle to a boarding area based on the traveler information. In certain embodiments, the process 400 may receive one or more notifications when the secure transport vehicle arrives at a departing gate area, when all the travelers and baggage items have been removed, or if any items are left behind, in which case the appropriate personnel may be alerted. The process 400 may then instruct the secure transport vehicle to return to a secure vehicle area or to the location of another traveler.

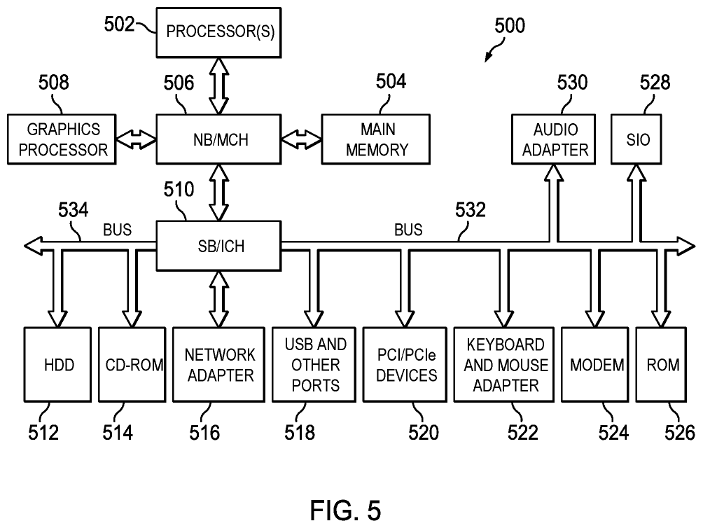

FIG. 5 is a block diagram illustrating a hardware architecture of a data processing system 500 according to an embodiment of the present disclosure in which aspects of the illustrative embodiments may be implemented. For example, in one embodiment, the requesting device 102 or secure transport control system 110 of FIG. 1 may be implemented using the data processing system 500. Additionally, the data processing system 500 may be configured to store and execute instructions for performing the process described in FIG. 4. In the depicted example, the data processing system 500 employs a hub architecture including north bridge and memory controller hub (NB/MCH) 506 and south bridge and input/output (I/O) controller hub (SB/ICH) 510. Processor(s) 502, main memory 504, and graphics processor 508 are connected to NB/MCH 506. Graphics processor 508 may be connected to NB/MCH 506 through an accelerated graphics port (AGP). A computer bus, such as bus 532 or bus 534, may be implemented using any type of communication fabric or architecture that provides for a transfer of data between different components or devices attached to the fabric or architecture.

In the depicted example, network adapter 516 connects to SB/ICH 510. Audio adapter 530, keyboard and mouse adapter 522, modem 524, read-only memory (ROM) 526, hard disk drive (HDD) 512, compact disk read-only memory (CD-ROM) drive 514, universal serial bus (USB) ports and other communication ports 518, and peripheral component interconnect/peripheral component interconnect express (PCI/PCIe) devices 520 connect to SB/ICH 510 through bus 532 and bus 534. PCI/PCIe devices 520 may include, for example, Ethernet adapters, add-in cards, and personal computing (PC) cards for notebook computers. PCI uses a card bus controller, while PCIe does not. ROM 526 may be, for example, a flash basic input/output system (BIOS). Modem 524 or network adapter 516 may be used to transmit and receive data over a network.

HDD 512 and CD-ROM drive 514 connect to SB/ICH 510 through bus 534. HDD 512 and CD-ROM drive 514 may use, for example, an integrated drive electronics (IDE) or serial advanced technology attachment (SATA) interface. In some embodiments, HDD 512 may be replaced by other forms of data storage devices including, but not limited to, solid-state drives (SSDs). A super I/O (SIO) device 528 may be connected to SB/ICH 510. SIO device 528 may be a chip on the motherboard that is configured to assist in performing less demanding controller functions for the SB/ICH 510 such as controlling a printer port, controlling a fan, and/or controlling the small light emitting diodes (LEDS) of the data processing system 500.

The data processing system 500 may include a single processor 502 or may include a plurality of processors 502. Additionally, processor(s) 502 may have multiple cores. For example, in one embodiment, data processing system 500 may employ a large number of processors 502 that include hundreds or thousands of processor cores. In some embodiments, the processors 502 may be configured to perform a set of coordinated computations in parallel.

An operating system is executed on the data processing system 500 using the processor(s) 502. The operating system coordinates and provides control of various components within the data processing system 500 in FIG. 5. Various applications and services may run in conjunction with the operating system. Instructions for the operating system, applications, and other data are located on storage devices, such as one or more HDD 512, and may be loaded into main memory 504 for execution by processor(s) 502. In some embodiments, additional instructions or data may be stored on one or more external devices. The processes described herein for the illustrative embodiments may be performed by processor(s) 502 using computer usable program code, which may be located in a memory such as, for example, main memory 504, ROM 526, or in one or more peripheral devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for providing secure transport in a transportation facility, the computer-implemented method comprising:
receiving a request for a secure transport service from a requesting device;
receiving traveler information associated with the request for the secure transport service, wherein the traveler information includes a weight of the travelers and baggage items associated with the travelers;
selecting a secure transport vehicle based on the traveler information;
initiating a security check of travelers and baggage items on the secure transport vehicle, wherein the security check includes verifying that the weight of the travelers and baggage items corresponding to the traveler information matches the weight of the travelers and baggage items onboard the secure transport vehicle;
initiating security measures in response to a determination that the travelers and baggage items failed the security check; and
initiating transport of the travelers and baggage items on the secure transport vehicle to a boarding area based on the traveler information in response to a determination that the travelers and baggage items passed the security check.

2. The computer-implemented method of claim 1, wherein the security check comprises performing a body scan of the travelers using a terahertz imaging scanner integrated on the secure transport vehicle.

3. The computer-implemented method of claim 1, further comprising verifying an identity of the travelers based on the traveler information.

4. The computer-implemented method of claim 3, wherein the traveler information comprises a fingerprint scan.

5. The computer-implemented method of claim 3, wherein the traveler information comprises a facial image scan.

6. The computer-implemented method of claim 1, wherein the traveler information comprises a number of the travelers and the baggage items.

7. (canceled)

8. The computer-implemented method of claim 1, wherein the security measures comprise notifying the travelers of any prohibited items detected during the security check.

9. The computer-implemented method of claim 1, wherein the security measures comprise notifying security personnel of any prohibited items detected during the security check.

10. The computer-implemented method of claim 1, wherein the security measures comprise prohibiting movement of the secure transport vehicle.

11. The computer-implemented method of claim 1, wherein the security measures comprise prohibiting removal of the baggage items from a compartment of the secure transport vehicle.

12. The computer-implemented method of claim 1, wherein the travelers and baggage items on the secure transport vehicle are transported within a closed secure environment.

13. The computer-implemented method of claim 1, further comprising monitoring the secure transport vehicle during transport to identify suspicious activity.

14. The computer-implemented method of claim 1, further comprising verifying that all the travelers and the baggage items are removed from the secure transport vehicle at the boarding area.

15. The computer-implemented method of claim 1, further comprising instructing the secure transport vehicle to return to a secure vehicle area after verifying that all the travelers and the baggage items are removed from the secure transport vehicle at the boarding area.

16. A system configured to provide secure transport in a transportation facility, the system comprising memory for storing instructions, and a processor configured to execute the instructions to:
receive a request for a secure transport service from a requesting device;
receive traveler information associated with the request for the secure transport service, wherein the traveler information includes a weight of the travelers and baggage items associated with the travelers;
initiate a security check of travelers and baggage items on a secure transport vehicle, wherein the security check includes verifying that the weight of the travelers and baggage items corresponding to the traveler information matches the weight of the travelers and baggage items onboard the secure transport vehicle;
initiate security measures in response to a determination that the travelers and baggage items failed the security check; and
initiate transport of the travelers and baggage items on the secure transport vehicle to a boarding area based on the traveler information in response to a determination that the travelers and baggage items passed the security check.

17. The system of claim 16, wherein the processor further executes instructions to select the secure transport vehicle from a plurality of secure transport vehicles based on the traveler information.

18. (canceled)

19. The system of claim 16, wherein the security measures comprises prohibiting removal of the baggage items containing prohibited items from a compartment of the secure transport vehicle.

20. A secure transport vehicle comprising:
a set of passenger seats;
a terahertz imaging scanner configured to perform a security scan of travelers within the secure transport vehicle;
a secure baggage compartment;
an x-ray scanner configurable to scan baggage located within the secure baggage compartment;
a weight sensor configurable to determine a weight of the travelers and the baggage;
a processor configured to execute instructions to verify that a weight of the travelers and the baggage onboard the secure transport vehicle matches the weight of the travelers and the baggage received prior to the travelers and the baggage boarding the secure transport vehicle;
a camera configured to capture images of the travelers; and
a display monitor configured to display travel information to the travelers.
